(19) United States
(12) Patent Application Publication
(10) Pub. No.: US 2025/0278445 A1
(43) Pub. Date: Sep. 4, 2025

(54) SYSTEMS AND METHODS FOR AUTOMATED ONLINE CONTENT CURATION

(71) Applicant: The Public Health Company Group, Inc., Palo Alto, CA (US)

(72) Inventors: Travis CARTER, Palo Alto, CA (US); Charity DEAN, Palo Alto, CA (US); Nick DEWIND, Palo Alto, CA (US); Ben JEFFREY, Palo Alto, CA (US); Shane JOHNSON, Palo Alto, CA (US); Chris LATKO, Palo Alto, CA (US); Sumiko MEKARU, Palo Alto, CA (US); Michelle NOLAN, Palo Alto, CA (US); Kelly PIERCE, Palo Alto, CA (US); Dartanion SWIFT-WILLIAMS, Palo Alto, CA (US)

(21) Appl. No.: 19/067,495

(22) Filed: Feb. 28, 2025

Related U.S. Application Data
(60) Provisional application No. 63/560,403, filed on Mar. 1, 2024.

(51) Int. Cl. G06F 16/9535; G06F 16/353; G06F 40/30

(52) U.S. Cl. CPC G06F 16/9535; G06F 16/353; G06F 40/30

(57) ABSTRACT

A method for automated online content curation includes retrieving a plurality of items of online content, each item of online content comprising a body and a summative text string. For each item of online content, the text string is compared to a set of search terms associated with a scenario. For each item of online content whose text string matches at least one search term in the set of search terms, a semantic deduplication is performed that assigns the text string to one or more clusters. For each of the one or more clusters, a relevance classification is performed that characterizes the relevance of the cluster to the scenario according to one of a plurality of relevance classes. For each item of online content, the item of online content is tagged so as to reflect the relevance class of its associated cluster.

### CROSS REFERENCE TO RELATED APPLICATION

This application claims priority to Provisional Application No. 63/560,403, filed Mar. 1, 2024, the entire contents of which are hereby expressly incorporated by reference herein.

### BACKGROUND

The present invention relates to systems and methods for automated online content curation.

It is increasingly the case that information regarding current events is found mostly online. However, due to the rapidly changing nature of online content, as well as the amount of online content and the amount of duplicative and potentially irrelevant information from an ever-expanding number of online sources, it is increasingly difficult to curate online content from a variety of sources in a way that enables the presentation of relevant and timely information to those interested.

For example, major news organizations may publish information (e.g., news articles, blurbs, etc.) across multiple platforms, including websites, social media channels, and mobile applications. Independent journalists, bloggers, and citizen reporters also contribute to the information stream through various online platforms (e.g., Substack, Medium, etc.) and personal websites. The increasing multiplicity of sources makes it difficult to systematically monitor the information ecosystem effectively.

It is therefore desirable to provide systems and methods for automated online content curation as described herein.

### BRIEF SUMMARY OF THE INVENTION

Systems and methods are disclosed for automated online content curation.

Other objects, advantages and novel features of the present invention will become apparent from the following detailed description of one or more preferred embodiments when considered in conjunction with the accompanying drawings. It should be recognized that the one or more examples in the disclosure are non-limiting examples and that the present invention is intended to encompass variations and equivalents of these examples.

### BRIEF DESCRIPTION OF THE DRAWINGS

The features, objects, and advantages of the present invention will become more apparent from the detailed description, set forth below, when taken in conjunction with the drawings, in which like reference characters identify elements correspondingly throughout.

FIG. 1 illustrates an exemplary system in accordance with at least one embodiment; and

FIG. 2 illustrates an exemplary method in accordance with at least one embodiment.

### DETAILED DESCRIPTION OF THE PREFERRED EMBODIMENTS

The above described drawing figures illustrate the present invention in at least one embodiment, which is further defined in detail in the following description. Those having ordinary skill in the art may be able to make alterations and modifications to what is described herein without departing from its spirit and scope. While the present invention is susceptible of embodiment in many different forms, there is shown in the drawings and will herein be described in detail at least one preferred embodiment of the invention with the understanding that the present disclosure is to be considered as an exemplification of the principles of the present invention, and is not intended to limit the broad aspects of the present invention to any embodiment illustrated.

In accordance with the practices of persons skilled in the art, the invention is described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, code segments perform certain tasks described herein. The code segments can be stored in a processor readable medium. Examples of the processor readable mediums include an electronic circuit, a semiconductor memory device, a read-only memory (ROM), a flash memory or other non-volatile memory, a floppy diskette, a CD-ROM, an optical disk, a hard disk, etc.

In the following detailed description and corresponding figures, numerous specific details are set forth in order to provide a thorough understanding of the present invention. However, it should be appreciated that the invention may be practiced without such specific details. Additionally, well-known methods, procedures, components, and circuits have not been described in detail.

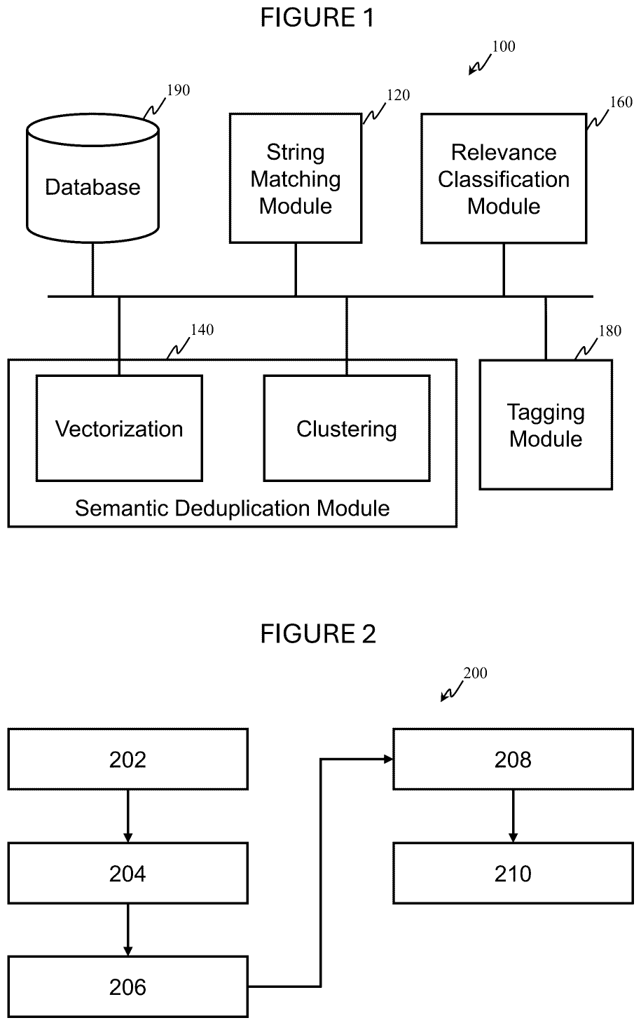

The present invention generally relates to systems and methods for automated online content curation. FIG. 1 is a schematic representation of an automated online content curation system 100 in accordance with one or more aspects of the invention.

The automated online content curation system may include one or more computing devices (e.g., computers, etc.) operatively connected to one or more storage devices via a network. The computing devices may include different types of components associated with computing devices, such as one or more processors, memory, software and/or firmware instructions, data, displays, and interfaces.

The processor may instruct the components of the computing device to perform various tasks based on the software/firmware instructions and/or data stored in the memory. The processor may be a standard processor, such as a central processing unit (CPU), or may be a dedicated processor, such as a graphics processing unit (GPU), an application-specific integrated circuit (ASIC) or a field programmable gate array (FPGA).

The memory may store at least software/firmware instructions and/or data that can be accessed by the processor. For example, the memory may be hardware capable of storing information accessible by the processor, such as a ROM, RAM, hard-drive, CD-ROM, DVD, write-capable, read-only, etc. It should be noted that the terms “instructions,” “steps,” “algorithms,” and “programs” may be used interchangeably to refer to software/firmware that may be implemented by the processor. The data can be retrieved, manipulated or otherwise stored by the processor in accordance with the software/firmware, and may be stored as a collection of data.

The display may be any type of device capable of communicating data to a user, such as a liquid-crystal display (LCD) screen, a plasma screen, etc. The interface may be any type of device that allows a user to communicate with the computing device, and may be a physical device (e.g., a port, a keyboard, a mouse, a touch-sensitive screen, microphone, camera, a universal serial bus (USB), CD/DVD drive, zip drive, card reader, etc.) and/or may be virtual (e.g., a graphical user interface (GUI), etc.).

The storage device may be configured to store large quantities of data and/or information. For example, the storage device may be a collection of storage components, or a mixed collection of storage components, such as ROM, RAM, hard-drives, solid-state drives, removable drives, network storage, virtual memory, cache, registers, etc. The storage device may also be configured so that the computing device may access it via the network.

The network may be any type of network, wired or wireless, configured to facilitate the communication and transmission of data, instructions, etc. from one component to another component of the network. For example, the network may be a local area network (LAN) (e.g., Ethernet or other LAN-based network), Wi-Fi (e.g., wide area network (WAN), virtual private network (VPN), global area network (GAN), etc.), any combination thereof, or any other type of network.

As shown in FIG. 1, the automated online content curation system includes a text-string matching module 120, a semantic deduplication module 140, a relevance classification module 160, a tagging module 180, and at least one database 190. The automated online content curation system is generally configured to automatically curate online content according to a determined relevance of the content to a scenario.

The online content may be any item of digital content distributed or otherwise stored online, such as for example, news articles, social media posts, press releases, scientific and non-scientific publications, government communications, policy documents, or the like. The online content generally includes a body that contains information to be conveyed to a consumer of the online content, and a text string (e.g., a title, etc.) that is summative of the information contained in the body. The body may also be text-based, in at least one embodiment.

The online content may be retrieved from one or more online content sources and stored in the database for curation by the automated online content curation system. The automated online content curation system is indeed generally configured to process online content from any source, including but not limited to: news organizations, independent and/or citizen journalists, scientific organizations, governments, etc.

The text-string matching module 120 is generally configured to carry out text-based pattern matching of the summative text string with a set of search terms in order to identify text patterns in the summative text string that match one or more of the search terms. The text-string matching module may, for example, utilize regular expression (also referred to as rational expression) text matching algorithms and/or methodologies to identify text patterns in the summative text string that match one or more of the search terms. However, other text-based pattern matching algorithms and/or methodologies may be used without departing from the scope of the invention. The text-based pattern matching is generally done for each item of online content.

The set of search terms is generally associated with one or more scenarios and each scenario is generally associated with one or more sets of search terms. In some embodiments, the association of scenarios with search terms is predefined. The scenario may be set by the user (e.g., via the interface) in advance of the text-based pattern matching in accordance with the automated online content curation. In some embodiments, the search term set is stored as a .yaml file that can be modified through the addition and/or removal of search terms.

For example, a scenario may be a predefined infections disease scenario (e.g., an anthrax outbreak). The infectious disease scenario (e.g., anthrax outbreak) may be associated with infectious disease related public health search terms, such as: anthrax, as well as alternative spellings, misspellings, abbreviations, capitalizations, alternative names, and various perturbations of the same.

In some embodiments, the search terms may be coded for regular expression that allows for complex pattern matching and exclusions of strings likely to result in misclassification. For example, “anthrax” is both a pathogen and a rock band, but scenario refers to the pathogen, so the regular expression coding would exclude text-strings likely referring to the rock band (e.g., excludes “anthrax” within 1-word of “band”). In some embodiments, approximate string matching (i.e., “fuzzy” string matching) may be used as an alternative to regular expression search terms.

Where the text-based pattern matching does not identify one or more text patterns in the summative text string that match one or more of the search terms, the corresponding online content may be associated with a first tag indicating that the online content is not relevant to the scenario (i.e., a first class). The online content associated with the first tag may thereafter be stored in the database without undergoing further automated curation by the automated online content curation system. Accordingly, the text-string matching module may be configured to associate the online content with the first tag and/or to store the tagged online content in the database. In some embodiments, however, the tagging and storing of the online content is carried out by an appropriately configured tagging module.

Where the text-based pattern matching does identify one or more text patterns in the summative text string that match one or more of the search terms, the summative text string may be passed to the semantic deduplication module.

The semantic deduplication module 140 is generally configured to apply semantic deduplication algorithms and/or methodologies to the received text strings in order to group the text strings into semantically similar clusters.

In at least one embodiment, the semantic deduplication module is configured to utilize text vectorization algorithms and/or methodologies to generate a text string vector from the text string. The text string vector may reflect the text string in an n-dimensional semantic vector space. The text string vector may be stored in the database along with other text string vectors associated with other online content.

Text vectorization algorithms include trained AI models such as transformers, long short-term memory (LSTM) neural networks, and recurrent neural networks. Other text vectorization models include sequence matching, term frequency-inverse document frequency (TF-IDF), and W-shingling models, for example.

In at least one embodiment, the semantic deduplication module is configured to apply vector clustering algorithms and/or methodologies to the text string vectors stored in the database in order to generate and/or modify one or more semantic clusters. The vector clustering algorithms generally apply semantic deduplication on the vectorized text to calculate the cosine distance between each pair of text vectors in the vector space. In some embodiments, the Euclidian distance may be used instead. In general, vector pairs with small distances will be grouped together; vector pairs with large distances will be assigned to different semantic clusters.

For example, the semantic deduplication module may utilize agglomerative clustering, density-based spatial clustering of applications with noise (DBSCAN) clustering, divisive clustering, or any other text vector clustering technique.

Each semantic cluster may comprise one or more text string vectors corresponding to respective items of online content that are semantically similar. That is to say that each item of online content may be associated with (e.g., mapped to) the semantic cluster comprising its text string vectors and semantically similar text string vectors of other items of online content. Accordingly, the semantic deduplication module may be configured to associate (e.g., map) the text string vector and semantic cluster with the corresponding item of online content stored in the database.

The relevance classification module 160 is generally configured, alone or in combination with the tagging module discussed herein, to classify each semantic cluster and/or the associated items of online content as belonging to one of a plurality of relevance classes characterizing its relevance to the scenario. The relevance classification module may comprise a machine learning model, such as a random forest model or an XGBoost model. Other types of usable models include logistic regression, multinomial regression, naïve Bayes, and support vector machine.

In some embodiments, the classification is a binary classification in which the relevance classes are the first class (e.g., not relevant) and a second class (e.g., relevant). In some embodiment, the classification is a multinomial classification in which the relevance classes also include a third class in addition to the first and second classes. In such embodiments, the second class may indicate that the semantic cluster is relevant to a first audience (e.g., businesses, government, etc.) whereas the third class may indicate that the semantic cluster is relevant to a second audience (e.g., academics, experts, etc.). Additional classes indicating relevance to further audiences are also expressly contemplated.

The tagging module 180 is generally configured to apply tags to the items of online content in accordance with the relevance class. Thus, for example, where the item of online content is associated with a cluster of the second class, the tagging module tags the item of online content with a second tag corresponding to that second class.

In some embodiments, for each semantic cluster, the relevance classification module receives the text string vectors corresponding to respective items of online content for the semantic cluster. The relevance classification module then classifies each of the items of online content for the semantic cluster. The semantic deduplication module then identifies a central vector of the semantic cluster. The tagging module then applies the tag corresponding to the class of the online content corresponding to the central vector to each of the items of online content of the semantic cluster. As used herein the “central vector” refers to the text string vector of the cluster that is closest to the center of the semantic cluster in the vector space.

In some embodiments, for each semantic cluster, the relevance classification module receives the text string vectors corresponding to respective items of online content for the semantic cluster. The semantic deduplication module then identifies the central vector of the semantic cluster. The relevance classification module then classifies the online content corresponding to the central vector. The tagging module then applies the tag corresponding to class of the online content corresponding to the central vector to each of the online content of the semantic cluster.

In some embodiments, the relevance classification receives the text string vectors corresponding to respective items of online content for the semantic cluster. The relevance classification module then classifies the semantic cluster in aggregate and applies the appropriate tag to the semantic cluster.

The tagged online content may be retrievably stored in the database 190 and accessible by the user via the interface. For example, the online content may be accessed by the user in the form of online content that is now curated and organized according to tags indicating potential relevance.

In at least one embodiment, human-in-the-loop verified classifications and/or tags may be provided to the machine learning module as training data.

FIG. 2 is a flow-chart that represents an exemplary method 200 for automated online content curation in accordance with one or more aspects of the invention. At step 202, online content may be retrieved from one or more online content sources and stored in the database for curation by the automated online content curation system, as described herein. At step 204, the text-string matching module may carry out the text-based pattern matching as described herein. Where the text-based pattern matching identifies one or more text patterns matching one or more search terms, the summative text string may be passed to the semantic deduplication module. At step 206, the semantic deduplication module may apply semantic deduplication algorithms and/or methodologies to received text strings in order to group the text strings into semantically similar clusters. At step 208, the relevance classification module may, alone or in combination with the tagging module, classify and/or tag each semantic cluster and/or the associated items of online content as belonging to one of a plurality of relevance classes characterizing its relevance to the scenario. At step 210, the tagged online content may be retrievably stored in the database for retrieval by the user via the interface.

The embodiments described in detail above are considered novel over the prior art and are considered critical to the operation of at least one aspect of the described systems, methods and/or apparatuses, and to the achievement of the above-described objectives. The words used in this specification to describe the instant embodiments are to be understood not only in the sense of their commonly defined meanings, but to include by special definition in this specification: structure, material or acts beyond the scope of the commonly defined meanings. Thus, if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense, it is therefore contemplated that an equivalent substitution of two or more elements may be made for any one of the elements described and its various embodiments or that a single element may be substituted for two or more elements.

Changes from the subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

Furthermore, the functionalities described herein may be implemented via hardware, software, firmware or any combination thereof, unless expressly indicated otherwise. If implemented in software, the functionalities may be stored in a memory as one or more instructions on a computer readable medium, including any available media accessible by a computer that can be used to store desired program code in the form of instructions, data structures or the like. Thus, certain aspects may comprise a computer program product for performing the operations presented herein, such computer program product comprising a computer readable medium having instructions stored thereon, the instructions being executable by one or more processors to perform the operations described herein. It will be appreciated that software or instructions may also be transmitted over a transmission medium as is known in the art. Further, modules and/or other appropriate means for performing the operations described herein may be utilized in implementing the functionalities described herein.

The foregoing disclosure has been set forth merely to illustrate the invention and is not intended to be limiting. Since modifications of the disclosed embodiments incorporating the spirit and substance of the invention may occur to persons skilled in the art. the invention should be construed to include everything within the scope of the described embodiments and equivalents thereof.

1. A method for automated online content curation, the method comprising:
retrieving a plurality of items of online content, each item of online content comprising a body and a summative text string;
for each item of online content, comparing the text string to a set of search terms associated with a scenario;
for each item of online content whose text string matches at least one search term in the set of search terms, performing a semantic deduplication that assigns the text string to one or more clusters;
for each of the one or more clusters, performing a relevance classification that characterizes the relevance of the cluster to the scenario according to one of a plurality of relevance classes;
for each item of online content, tagging the item of online content so as to reflect the relevance class of its associated cluster.

2. The method of claim 1, further comprising:
for each item of online content whose text string does not match at least one search term in the predefined list, tagging the item of online content as not relevant.

3. The method of claim 1, wherein performing the semantic deduplication includes:
vectorizing the text string to generate a corresponding text-vector; and
clustering the text-vector with a plurality of other text-vectors so as to form a semantic cluster based on a semantic similarity between the text-vector and the other text-vectors.

4. The method of claim 1, wherein the tagged online content is stored in the database.

5. The method of claim 1, wherein the relevance classification is a binary classification.

6. The method of claim 1, wherein the relevance classification is a multinomial classification.

7. The method of claim 6, wherein the multinomial classification reflects the relevance of the cluster to different audience types.
